(19) United States
(12) Patent Application Publication
(10) Pub. No.: US 2023/0243341 A1
(43) Pub. Date: Aug. 3, 2023

(54) WIND POWER GENERATION DEVICE

(71) Applicant: TOYOTA JIDOSHA KABUSHIKI KAISHA, Aichi-ken (JP)

(72) Inventors: Sou MORISHITA, Nagoya-shi (JP); Kunihiro KOBAYASHI, Toyota-shi (JP); Kazuaki ISHIURA, Okazaki-shi (JP); Suguru JIMBO, Tokai-shi (JP)

(21) Appl. No.: 18/059,448

(22) Filed: Nov. 29, 2022

(30) Foreign Application Priority Data
Feb. 3, 2022 (JP) 2022-015747

(51) Int. Cl. F03D 15/00; F03D 9/25

(52) U.S. Cl. CPC F03D 15/00; F03D 9/25; F05B 2260/4031; F05B 2260/4023

(57) ABSTRACT

The wind power generation device comprises a blade. The wind power generation device includes a speed increaser to which power output from the blade is input. The wind power generation device includes a generator to which power output from the speed increaser is input. The wind power generation device includes a torque limiter portion provided on at least one of a power transmission path between the blade and the speed increaser or a power transmission path between the speed increaser and the generator. The torque limiter portion includes a first shaft. The torque limiter portion includes a second shaft disposed coaxially with the first shaft. The torque limiter portion includes a plate provided on the first shaft and having a plane perpendicular to the first shaft. The torque limiter portion is provided on the second shaft and includes a sandwiching portion that sandwiches the plate.

### CROSS-REFERENCE TO RELATED APPLICATION

This application claims priority to Japanese Patent Application No. 2022-015747 filed on Feb. 3, 2022, incorporated herein by reference in its entirety.

### BACKGROUND

### 1. Technical Field

A technique disclosed in the present specification relates to a wind power generation device.

### 2. Description of Related Art

Japanese Unexamined Patent Application Publication No. 2015-140780 (JP 2015-140780 A) discloses a wind power generation device in which an output shaft of a speed increaser is provided with a hollow shaft that is likely to be torsionally elastically deformed. When an excessive torque is instantaneously generated, the hollow shaft is elastically deformed, so that the excessive torque can be attenuated.

### SUMMARY

According to the technique disclosed in JP 2015-140780 A, when an excessive torque is continuously input, the excessive torque cannot be attenuated. Therefore, mechanical stress may be generated in a speed increaser or a generator. The present specification provides a technique capable of solving such a problem.

A wind power generation device disclosed in the present specification includes a blade. The wind power generation device includes a speed increaser to which power output from the blade is input. The wind power generation device includes a generator to which power output from the speed increaser is input. The wind power generation device includes a torque limiter portion provided on at least one of a power transmission path between the blade and the speed increaser, and a power transmission path between the speed increaser and the generator. The torque limiter portion includes a first shaft. The torque limiter portion includes a second shaft disposed coaxially with the first shaft. The torque limiter portion includes a plate that is provided on the first shaft and that includes a plane perpendicular to the first shaft. The torque limiter portion includes a sandwiching portion that is provided on the second shaft and that sandwiches the plate.

In the torque limiter portion, power can be transmitted by frictional force between the sandwiching portion and the plate. When an excessive torque equal to or higher than an upper limit is transmitted to the power transmission path, the plate slips, so that the transmitted torque can be maintained within an upper limit torque. Even when the excessive torque is continuously input, the excessive torque is not transmitted to the speed increaser or the generator, and thus it is possible to suppress the mechanical stress from being applied to the speed increaser or the generator.

The torque limiter portion may be disposed between the speed increaser and the generator. The first shaft may be connected to the speed increaser. The second shaft may be connected to the generator. Alternatively, the torque limiter portion may be disposed between the speed increaser and the generator. The first shaft may be connected to the generator. The second shaft may be connected to the speed increaser. In the above-described configuration, the torque output from the blade can be reduced via the speed increaser and then input to the torque limiter portion. A size of the torque limiter portion can be reduced as compared with a configuration in which torque is directly input from the blade to the torque limiter portion.

The torque limiter portion may be disposed between the blade and the speed increaser. The first shaft may be connected to the blade. The second shaft may be connected to the speed increaser. Alternatively, the torque limiter portion may be disposed between the blade and the speed increaser, the first shaft may be connected to the speed increaser, and the second shaft may be connected to the blade. In the above configuration, since the torque output from the blade is input to the speed increaser via the torque limiter portion, it is possible to suppress the excessive torque from being transmitted to the speed increaser. A size of the speed increaser can be reduced as compared with a configuration in which torque is directly input from the blade to the speed increaser.

The torque limiter portion may include a plurality of the plates. The plates may be disposed on the first shaft so as to be spaced apart from each other. The sandwiching portion may sandwich each of the plates. As a result, it is possible to realize the same upper limit torque while reducing a diameter of the plate as compared with a case where the torque limiter portion is composed of one plate.

The sandwiching portion may sandwich the plate in an axial direction of the first shaft.

The sandwiching portion may include an elastic member that applies sandwiching force.

The plate may be exposed to atmosphere. This makes it possible to simplify a structure and improve maintenance as compared with a structure in which the plate is immersed in a liquid.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a wind power generation device 1 according to a first embodiment;

FIG. 2 is a schematic configuration diagram of a wind power veneration device 1a according to a second embodiment;

FIG. 3 is a schematic configuration diagram of a wind power generation device 1b according to a third embodiment;

FIG. 4 is a schematic configuration diagram of a wind power generation device 1c according to a fourth embodiment; and

FIG. 5 is a schematic configuration diagram of a wind power generation device 1d according to a fifth embodiment.

### DETAILED DESCRIPTION OF EMBODIMENTS

### Example 1

### Configuration of Wind Power Generation Device 1

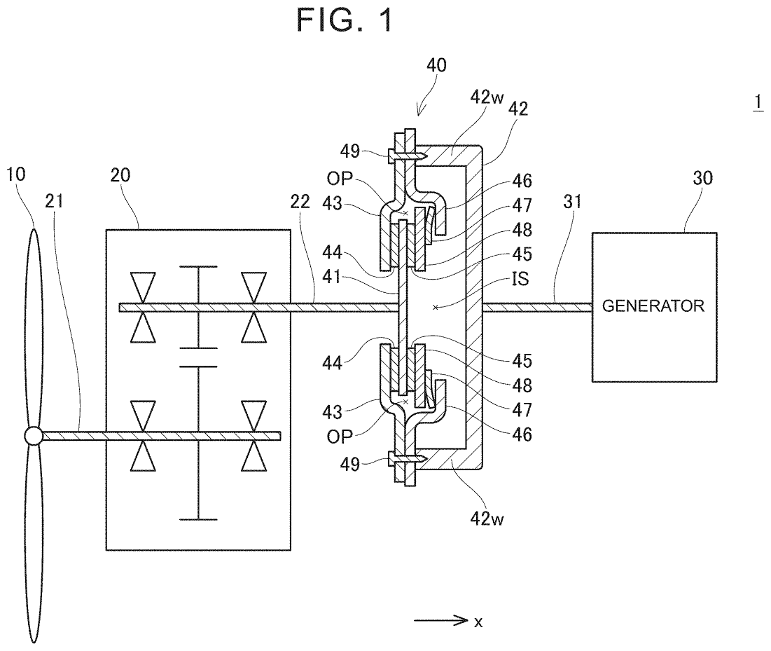

FIG. 1 is a schematic configuration diagram of a wind power generation device 1. The wind power generation device 1 mainly includes a blade 10, a speed increaser 20, a generator 30, and a torque limiter portion 40. In FIG. 1, the ratio of the sizes of the constituent elements is different from the actual ratio.

The speed increaser 20 includes a speed increaser input shaft 21 on the low-speed rotation side and a speed increaser output shaft 22 on the high-speed rotation side. The speed increaser 20 is a mechanism that increases the rotational driving force input to the speed increaser input shaft 21 in accordance with the speed increasing ratio and outputs the rotational driving force to the speed increaser output shaft 22. Since the structure of the speed increaser 20 is known, a description thereof will be omitted. The end of the speed increaser input shaft 21 is connected to the blade 10. An end portion of the speed increaser output shaft 22 is connected to the plate 41 of the torque limiter portion 40.

The generator 30 is a mechanism that outputs an alternating current by a power generation operation using power transmitted from the blade 10. Since the structure of the generator 30 is known, a description thereof will be omitted. The generator input shaft 31 included in the generator 30 is connected to the housing 42 of the torque limiter portion 40.

A torque limiter portion 40 is provided on a power transmission path between the speed increaser 20 and the generator 30. The torque limiter portion 40 is a mechanism capable of limiting the transmission torque so as not to exceed the torque upper limit value by slipping the plate 41 when a torque larger than the predetermined torque upper limit value is input. The torque upper limit value can be determined in advance based on the performance of the generator 30 or the like. The torque upper limit value can be adjusted by a pressing load of a belleville spring 47, which will be described later, a friction coefficient of the friction member 44 and the friction member 45, a diameter of the plate 41, and the like.

FIG. 1 shows a schematic cross-sectional view of a torque limiter portion 40. This cross-sectional view is a cross-sectional view in a plane passing through the speed increaser output shaft 22 and the generator input shaft 31. The torque limiter portion 40 has a rotationally symmetrical structure with respect to the speed increaser output shaft 22 and the generator input shaft 31. Therefore, a part of the structure of the torque limiter portion 40 will be described below. Further, in FIG. 1, an axial direction from the speed increaser output shaft 22 toward the generator input shaft 31 is defined as a positive x-direction.

The torque limiter portion 40 includes a speed increaser output shaft 22, a generator input shaft 31, a plate 41, a housing 42, a pinching plate 43, friction members 44 and 45, a spring holding plate 46, a Belleville spring 47, and a pressing plate 48. The speed increaser output shaft 22 and the generator input shaft 31 are arranged coaxially. In the first embodiment, the speed increaser output shaft 22 corresponds to the first shaft, and the generator input shaft 31 corresponds to the second shaft. A plate 41 is fixed to an end portion of the speed increaser output shaft 22 in the positive x-direction. The plate 41 is perpendicular to the speed increaser output shaft 22 and has a disk shape centered on the speed increaser output shaft 22.

A housing 42 is fixed to an end portion of the generator input shaft 31 in the negative x-direction. The housing 42 is perpendicular to the generator input shaft 31 and has a disk shape centered on the generator input shaft 31. The diameter of the housing 42 is larger than the diameter of the plate 41. An outer peripheral wall 42w is disposed on the outermost periphery of the housing 42 so as to protrude in the negative x-direction. As a result, an internal space IS that is open in the negative x-direction is formed.

A pinching plate 43 and a spring holding plate 46 are fixed to an end surface of the outer peripheral wall 42w in the negative x-direction by a fastening portion 49. The fastening portion 49 is, for example, a bolt. An opening OP having a U-shaped cross section is formed by the pinching plate 43 and the spring holding plate 46. A friction member 44 is fixed or held on a surface of the pinching plate 43 on the positive x-direction side. A pressing plate 48 is disposed on a surface of the spring holding plate 46 on the negative x-direction side via a Belleville spring 47. A friction member 45 is fixed or held on a surface of the pressing plate 48 on the-x direction side. A part of the plate 41 penetrates between the friction members 44 and 45. Since the Belleville spring 47 is mounted in a compressed state, the pressing plate 48 can be pressed in the negative x-direction by the belleville spring 47. Thus, the plate 41 can be sandwiched in the axial direction of the speed increaser output shaft 22 by the friction members 44 and 45. The belleville spring 47 is an example of an elastic member that applies sandwiching force.

The plate 41 is exposed to the atmosphere. That is, the torque limiter portion 40 is a dry limiter device. This makes it possible to simplify the structure and improve the maintainability as compared with the wet limiter device in which the plate 41 is immersed in the liquid.

### Effect

In the torque limiter portion 40, the friction force is generated between the friction members 44 and 45 and the plate 41 by the pressing load of the Belleville spring 47, and the power can be transmitted from the speed increaser 20 to the generator 30 by the friction force. When the excessive torque exceeding the predetermined torque upper limit value is input from the speed increaser 20, the plate 41 and the friction members 44 and 45 slip relatively to each other, so that the torque transmitted to the generator 30 can be maintained within the torque upper limit value. Even in a case where excessive torque is continuously input due to typhoon, gust wind, or the like, since the excessive torque is not transmitted to the generator 30, it is possible to suppress mechanical stress from being applied to the generator 30.

In the configuration of the first embodiment, the torque output from the blade 10 can be reduced via the speed increaser 20 and then input to the torque limiter portion 40. Since the torque capacity can be made smaller than the configuration in which the torque is directly input from the blade 10 to the torque limiter portion 40, the torque limiter portion 40 can be miniaturized.

When an excessive torque is input from the speed increaser output shaft 22, the speed increaser output shaft 22 is slipped and the rotation speed is discontinuously changed. Therefore, it is preferable that the mass of the mechanism connected to the speed increaser output shaft 22 is small and the rotational inertial force is small. Therefore, in the configuration of the first embodiment, the plate 41 is fixed to the speed increaser output shaft 22. The plate 41 has a smaller mass than the housing 42 because it has a smaller diameter and a smaller number of components. As a result, the speed increaser output shaft 22 can be smoothly slipped and rotated as compared with the case where the housing 42 is fixed to the speed increaser output shaft 22.

A mechanism used in various fields can be applied to the torque limiter portion 40. For example, a torque limiter portion used in a hybrid electric vehicle can be diverted. Since the torque limiter portion of the hybrid electric vehicle can be procured relatively inexpensively due to the mass production effect, the manufacturing cost of the wind power generation device 1 can be reduced.

### Example 2

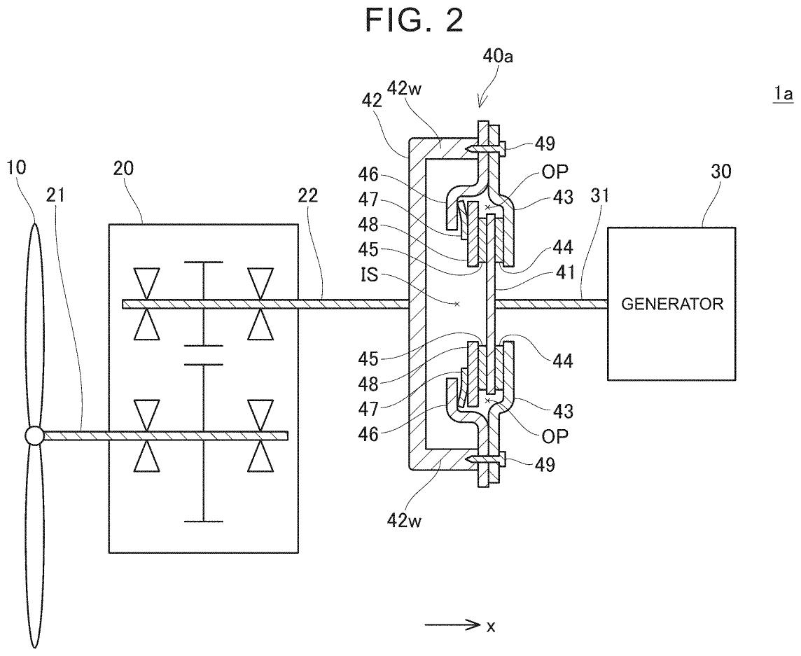

The wind power generation device 1a (FIG. 2) of the second embodiment is different from the wind power generation device 1 (FIG. 1) of the first embodiment in that a torque limiter portion 40a is provided. Parts common to the embodiments are denoted by the same reference numerals, and a description thereof will be omitted.

The torque limiter portion 40a of the second embodiment has a configuration in which the torque limiter portion 40 of the first embodiment is reversed in the x-direction. Therefore, the housing 42 is fixed to an end portion of the speed increaser output shaft 22 in the positive x-direction. A plate 41 is fixed to an end portion of the generator input shaft 31 in the negative x-direction. In the second embodiment, the generator input shaft 31 corresponds to the first shaft, and the speed increaser output shaft 22 corresponds to the second shaft.

The torque limiter portion 40a of the second embodiment can also achieve the same effect as the torque limiter portion 40 of the first embodiment.

### Example 3

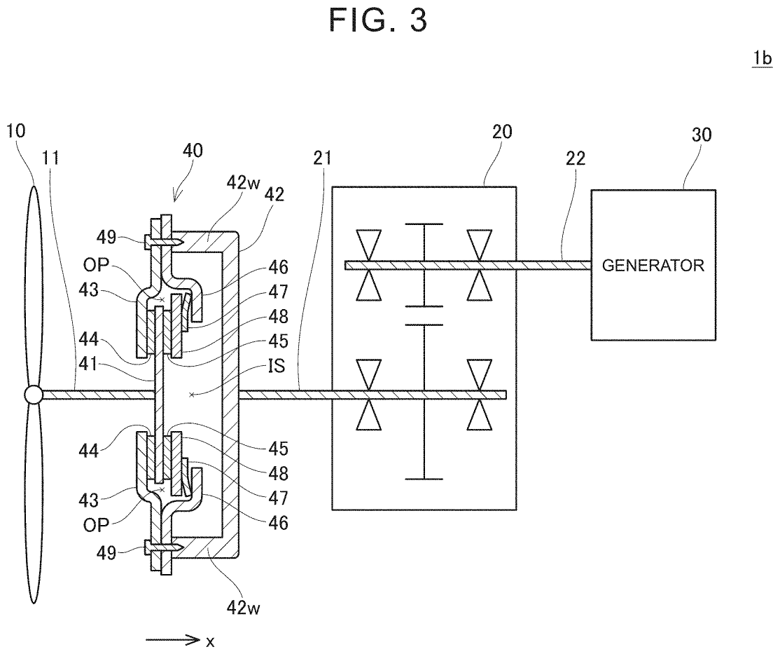

The wind power generation device 1b (FIG. 3) of the third embodiment is different from the wind power generation device 1 (FIG. 1) of the first embodiment in that a torque limiter portion 40 is provided on a power transmission path between the blade 10 and the speed increaser 20. Parts common to the embodiments are denoted by the same reference numerals, and a description thereof will be omitted.

The blade 10 comprises a blade output shaft 11. A plate 41 is fixed to an end portion of the blade output shaft 11 in the positive x-direction. A housing 42 is fixed to an end portion of the speed increaser input shaft 21 in the negative x-direction. In the third embodiment, the blade output shaft 11 corresponds to the first shaft, and the speed increaser input shaft 21 corresponds to the second shaft.

In the configuration of the third embodiment, the torque output from the blade 10 can be input to the speed increaser 20 via the torque limiter portion 40. As compared with a configuration in which torque is directly input from the blade 10 to the speed increaser 20, the margin coefficient for the input torque can be reduced, and thus the speed increaser 20 can be reduced in size.

### Modification of Example 3

The torque limiter portion 40 (FIG. 3) of the third embodiment may be replaced with the torque limiter portion 40a (FIG. 2) of the second embodiment. In this modification, the housing 42 is fixed to an end portion of the blade output shaft 11 in the positive x-direction. A plate 41 is fixed to an end portion of the speed increaser input shaft 21 in the negative x-direction. In this modification, the speed increaser input shaft 21 corresponds to the first shaft, and the blade output shaft 11 corresponds to the second shaft.

### Example 4

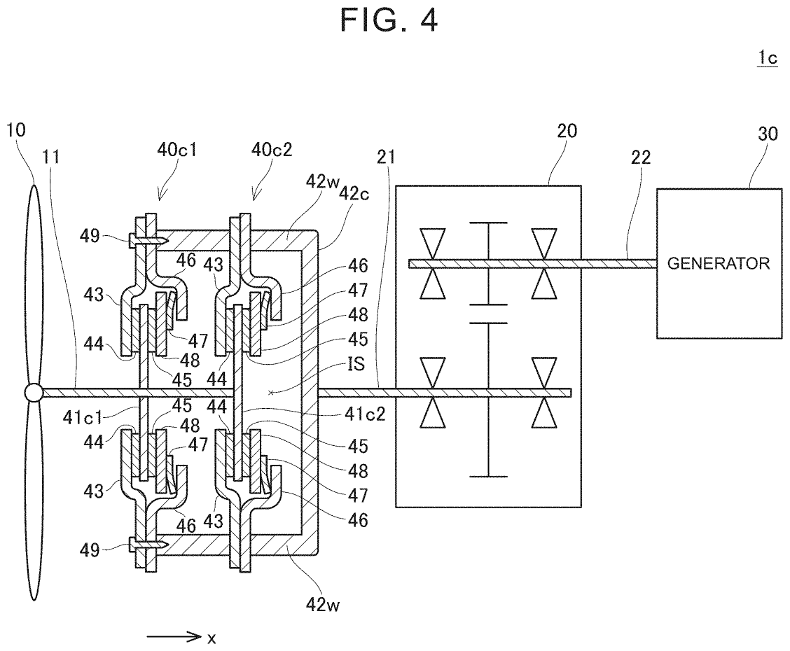

The wind power generation device 1c (FIG. 4) of the fourth embodiment is different from the wind power generation device 1b (FIG. 3) of the third. embodiment in that torque limiter portions 40c1 and 40c2 having a parallel structure are provided. Parts common to the embodiments are denoted by the same reference numerals, and a description thereof will be omitted.

The torque limiter portions 40c1 and 40c2 have the same structure as the torque limiter portion 40 of the first embodiment. The torque limiter portions 40c1 and 40c2 are disposed in one common housing 42c and rotate integrally. A housing 42c is fixed to an end portion of the speed increaser input shaft 21 in the negative x-direction. Plates 41c1 and 41c2 are fixed to the blade output shaft 11 in a state of being spaced apart from each other in parallel. Each of the plates 41c1 and 41c2 is sandwiched by the torque limiter portions 40c1 and 40c2. In the third embodiment, the blade output shaft 11 corresponds to the first shaft, and the speed increaser input shaft 21 corresponds to the second shaft.

### Effect

Power transmission can be performed by two torque limiter portions 40c1 and 40c2 arranged in parallel with the blade output shaft 11. As a result, it is possible to realize an equivalent upper limit torque value while reducing the diameter of the plate as compared with a case where power is transmitted by one torque limiter portion. It is possible to reduce the size of the wind power generation device 1.

### Modification of Example 4

The torque limiter portions 40c1 and 40c2 may be reversed in the x-direction. That is, the housing 42c may be fixed to an end portion of the blade output shaft 11 in the positive x-direction. The plates 41c1 and 41c2 may be fixed to the speed increaser input shaft 21. In this modification, the speed increaser input shaft 21 corresponds to the first shaft, and the blade output shaft 11 corresponds to the second shaft.

### Example 5

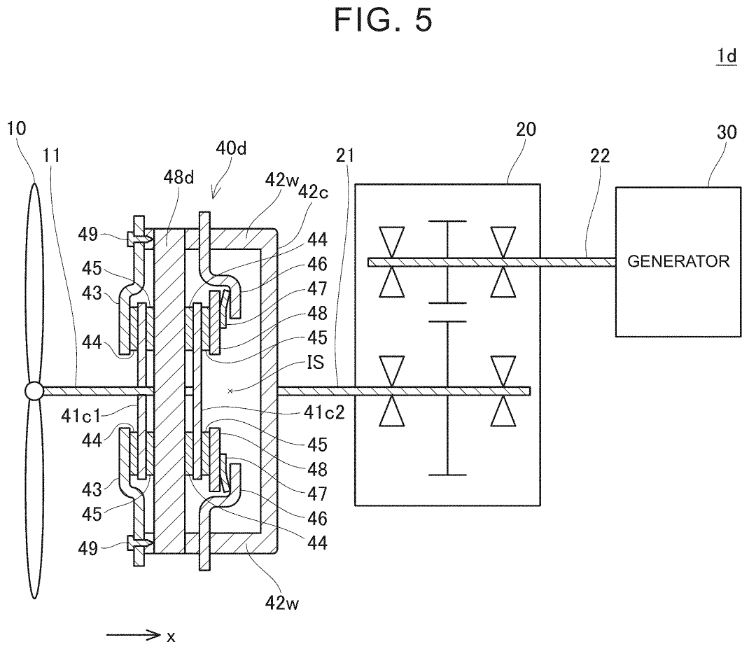

The wind power generation device 1d (FIG. 5) of the fifth embodiment is different from the wind power generation device is (FIG. 4) of the fourth embodiment in that a torque limiter portion 40d having a multi-plate structure is provided. Parts common to the embodiments are denoted by the same reference numerals, and a description thereof will be omitted.

In the torque limiter portions 40c1 and 40c2 of the fourth embodiment, the pinching plate 43, the spring holding plate 46, the Belleville spring 47, and the pressing plate 48 disposed between the plates 41c1 and 41c2 are omitted in the torque limiter portion 40d of the multi-plate structure of the fifth embodiment, Further, a pressing plate 48d is disposed between the friction members 44 and 45. The pressing plate 48d is non-rotatably attached to the outer peripheral wall 42w. Thus, one pressing plate 48d is shared between the friction members 44 and 45.

Since the torque limiter portion 40d has a multi-plate structure, the axial distance between the plates 41c1 and 41c2 can be reduced, so that the torque limiter portion 40d can be reduced in size. In addition, the number of parts can be reduced.

While the embodiments have been described in detail above, these are merely illustrative and do not limit the scope of the claims. The technology described in the claims includes various modifications and alterations of the specific examples described above. The technical elements described in this specification or in the drawings may be used alone or in various combinations, and are not limited to the combinations described in the claims at the time of filing. Further, the technology illustrated in the present specification or the drawings achieves a plurality of objects at the same time, and has technical usefulness by achieving one of the objects.

### Modified Example

The elastic member that applies the sandwiching force is not limited to the Belleville spring 47. Various aspects of the member may be used, such as a coil spring.

The present disclosure is not limited to a configuration in which sandwiching force is applied by an elastic member. For example, sandwiching force may be applied by a hydraulic mechanism.

Friction members 44 and 45 may be omitted. The plate may be sandwiched by the pinching plate 43 or the pressing plate 48.

In Examples 4 and 5, the case where two plates are used has been described, but the present disclosure is not limited to this configuration. Three or more plates may be used.

The technology of the present specification can be applied to any device as long as it is a power veneration device including a rotation mechanism. In the present embodiment, the case where the prime mover is the blade 10 for wind power has been described, but the present disclosure is not limited to this configuration. The types of prime movers may vary, such as hydraulic turbines, geothermal turbines, and the like.

What is claimed is:

1. A wind power generation device comprising:
a blade;
a speed increaser to which power output from the blade is input;
a generator to which power output from the speed increaser is input; and
a torque limiter portion provided on at least one of a power transmission path between the blade and the speed increaser, and a power transmission path between the speed increaser and the generator, wherein the torque limiter portion includes:
a first shaft;
a second shaft disposed coaxially with the first shaft;
a plate that is provided on the first shaft and that includes a plane perpendicular to the first shaft; and
a sandwiching portion that is provided on the second shaft and that sandwiches the plate.

2. The wind power generation device according to claim 1,
wherein the torque limiter portion is disposed between the speed increaser and the generator,
wherein the first shaft is connected to the speed increaser, and
wherein the second shaft is connected to the generator.

3. The wind power generation device according to claim 1,
wherein the torque limiter portion is disposed between the speed increaser and the generator,
wherein the first shaft is connected to the generator, and
wherein the second shaft is connected to the speed increaser.

4. The wind power generation device according to claim 1,
wherein the torque limiter portion is disposed between the blade and the speed increaser,
wherein the first shaft is connected to the blade, and
wherein the second shaft is connected to the speed increaser.

5. The wind power generation device according to claim 1,
wherein the torque limiter portion is disposed between the blade and the speed increaser,
wherein the first shaft is connected to the speed increaser, and
wherein the second shaft is connected to the blade.

6. The wind power generation device according claim 1,
wherein the torque limiter portion includes a plurality of the plates,
wherein the plates are disposed on the first shaft so as to be spaced apart from each other, and
wherein the sandwiching portion sandwiches each of the plates.

7. The wind power generation device according to claim 1, wherein the sandwiching portion sandwiches the plate in an axial direction of the first shaft.

8. The wind power generation device according to claim 1, wherein the sandwiching portion includes an elastic member that applies sandwiching force.

9. The wind power generation device according to claim 1, wherein the plate is exposed to atmosphere.
